(19) United States
(12) Patent Application Publication
(10) Pub. No.: US 2022/0337789 A1
(43) Pub. Date: Oct. 20, 2022

(54) SYSTEMS FOR MOUNTING AN INTERCOM DEVICE

(71) Applicant: Daniel BOSLEY, Belcamp, MD (US)

(72) Inventor: Daniel BOSLEY, Belcamp, MD (US)

(21) Appl. No.: 17/234,169

(22) Filed: Apr. 19, 2021

(51) Int. Cl. H04N 7/18

(52) U.S. Cl. CPC H04N 7/186

(57) ABSTRACT

Devices and methods for mounting intercom devices are described herein. The devices include a housing for receiving electrical components therein. The housing includes a back panel, side panels extending from the back panel, and a front panel coupled to the side panels. The front panel includes a perimeter, which, coupled to the side panels, forms a recess within the housing. The recess is configured to receive the intercom device such that the intercom device is flush with the front panel when the intercom device is fully inserted into the housing. The devices enable the intercom device to be mounted to mounting surfaces including corners of adjacent walls, framed structures, and openings inside the surface. This configuration alleviates complex or expensive installation and vandalism issues associated with intercom devices.

### TECHNICAL FIELD

The present disclosure relates to a system for mounting intercom devices and related methods.

### BACKGROUND

Intercom devices enable users to monitor building entrances, communicate with visitors, and view real-time images of the entrances and visitors. Often, these intercom devices are mounted directly to an exterior mounting surface. Current mounting techniques allow intercom devices to be susceptible to theft or vandalism. Flushmount systems provide one solution to vandalism issues; however, installation of flushmount systems requires the installer to dig and remove large cavities in the mounting surface. There is therefore a need for mounting devices that improve vandal-resistance and allows for wider ranges of installation options without the need to permanently alter the mounting surface.

### SUMMARY

An embodiment of the present disclosure is a system. The system includes a corner mounting device. The corner mounting device includes a base having a back panel. The base further includes side panels that extend from the back panel in a direction that is angularly offset relative to the back panel. The base includes a front panel attached to the side panels and generally opposite the back panel, and a recess that extends in to the base toward the back panel. The recess is configured to receive an intercom device. The corner mounting device further includes a front plate configured to be coupled to the front panel of the base. The front plate includes an external facing surface. The front plate further includes a rear surface opposite the external facing surface. The front plate further includes an opening that extends from the external facing surface to the rear surface and is aligned with the recess when the front plate is coupled to the base. A front facing surface of the intercom device is substantially flush with the external facing surface of the front plate when the intercom device is inserted into the recess.

Another embodiment of the present disclosure is a system. The system includes a frame mounting device. The frame mounting device includes a back panel. The frame mounting device further includes side panels that extend from the back panel in a direction that is perpendicular to the back panel. The frame mounting device further includes a front panel attached to the side panels and generally opposite the back panel. The frame mounting device further includes a recess that extends toward the back panel. The recess is configured to receive an intercom device. A front facing surface of the intercom device is substantially flush with the front panel when the intercom device is mounted in the recess of the frame mounting device.

Another embodiment of the present disclosure is a system. The system includes a surface mounting device. The surface mounting device includes a back panel. The surface mounting device further includes side panels that extend from the back panel in a direction that is perpendicular to the back panel. The surface mounting device further includes a front panel attached to the side panels and generally opposite the back panel. The surface mounting device further includes a recess that extends into the base toward the back panel. The recess is configured to receive an intercom device. A front facing surface of the intercom device is substantially flush with the front panel when the intercom device is mounted in the recess of the surface mounting device.

Another embodiment of the present disclosure is a method. The method includes securing a mounting device on a desired mounting surface. The mounting device has a recess for receiving an intercom device. The method further includes inserting electrical components of the intercom device through the mounting device. The method further includes inserting the intercom device into the recess of the mounting device. The method further includes securing the intercom device to the mounting device such that the intercom device is flush with the housing.

### BRIEF DESCRIPTION OF THE DRAWINGS

The foregoing summary, as well as the following detailed description of illustrative embodiments of the present application, will be better understood when read in conjunction with the appended drawings. For the purposes of illustrating the present application, there is shown in the drawings illustrative embodiments of the disclosure. It should be understood, however, that the application is not limited to the precise arrangements and instrumentalities shown. In the drawings:

FIG. 1 is a schematic plan view of a mounting system according to an embodiment of the present disclosure;

FIG. 2 is a front perspective view of a mounting device shown in FIG. 1, according to an embodiment of the present disclosure;

FIG. 3 is a front view of the mounting device shown in FIG. 2;

FIG. 4 is a rear perspective view of the mounting device shown in FIG. 2;

FIG. 5 is an exploded perspective view of the mounting device shown in FIG. 2;

FIG. 6 is a back perspective of a front panel of the mounting device shown in FIG. 2;

FIG. 7 is a perspective view of a mounting device according to another embodiment of the present disclosure;

FIG. 8 is a front view of the mounting device shown in FIG. 7;

FIG. 9 is a rear perspective view of the mounting device shown in FIG. 7;

FIG. 10 is a perspective view of a mounting device according to an embodiment of the present disclosure;

FIG. 11 is a front view of the mounting device shown in FIG. 10;

FIG. 12 is a rear perspective view of the mounting device shown in FIG. 10; and

FIG. 13 is a process flow diagram illustrating a method for installing the mounting system shown in FIG. 1.

### DETAILED DESCRIPTION OF ILLUSTRATIVE EMBODIMENTS

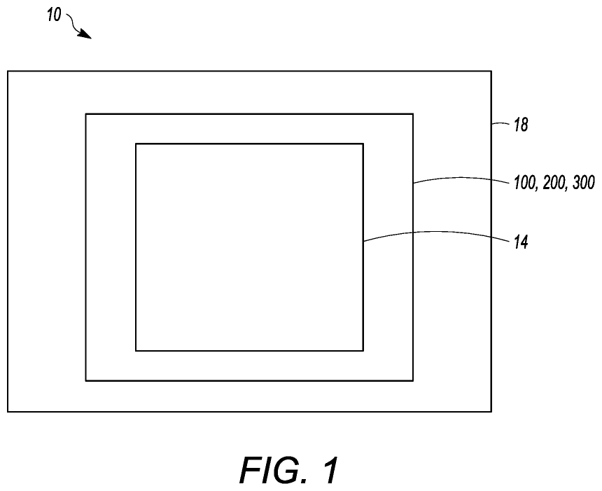

Referring to FIG. 1, embodiments of the present disclosure include a system 10 configured to install an intercom device 14 to a mounting surface 18 utilizing a mounting device 100, 200, 300. The mounting device 100, 200, 300 may be used to stabilize and affix and intercom device 14 on or inside a mounting surface 18. Current mounting processes and devices for intercom devices may leave the intercom device susceptible to vandalism once installed, as installed intercom devices may protrude from the mounting surfaces. In addition, current installation of intercom devices present complex and expensive construction and mounting surface excavation issues. The system 10 as described herein may be used to address or mitigate the impact of such issues.

As described herein, a mounting surface 18 may any surface of surfaces to which an intercom device can be affixed, such as a wall, corner, door frame, etc. In some instances, the mounting surface may be adjacent surfaces that form a corner. In some instances, the mounting surface 18 may a singular flat surface, such as any framed structure, including a door frame or a window frame. In yet other instances, the mounting surface 18 may be a surface having a large opening and configured to fit the mounting device and the intercom device inside of the opening. In the embodiments described herein, the system 10 may be used with existing intercom devices. For example, the system 10 may be utilized with the Axis A8105-E Flush Mount and Axis A8105-E Network Video Door Station devices. In an alternative embodiment, the system 10 may be used with various intercom devices not yet manufactured.

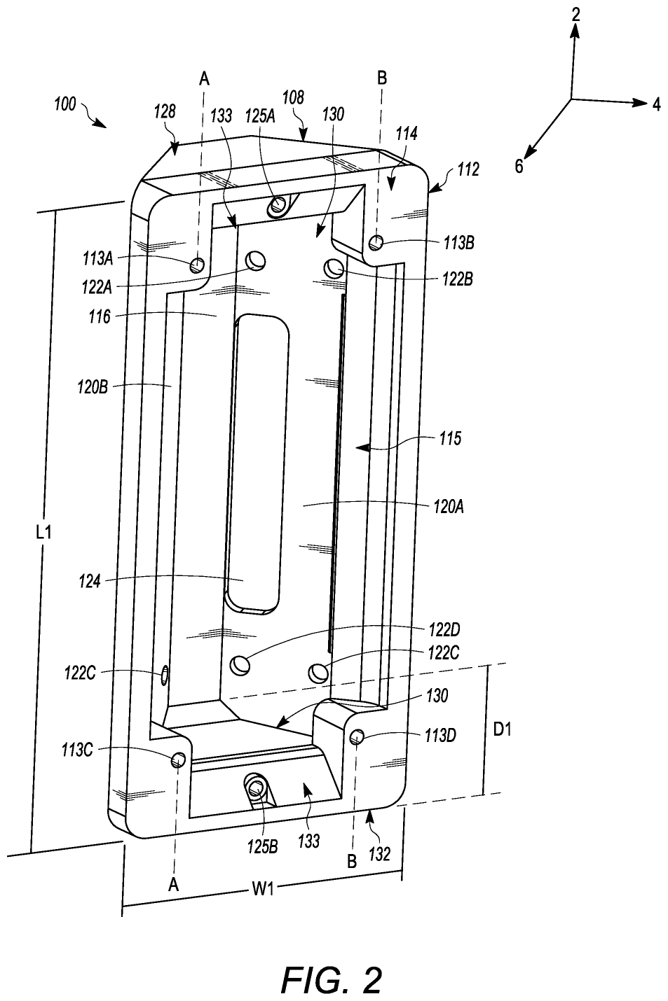

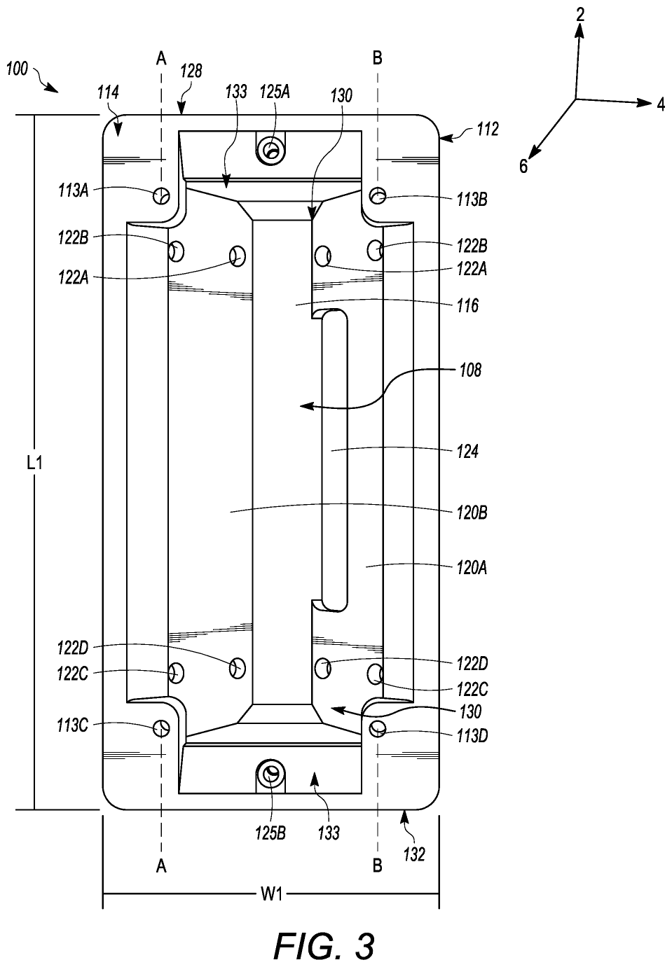

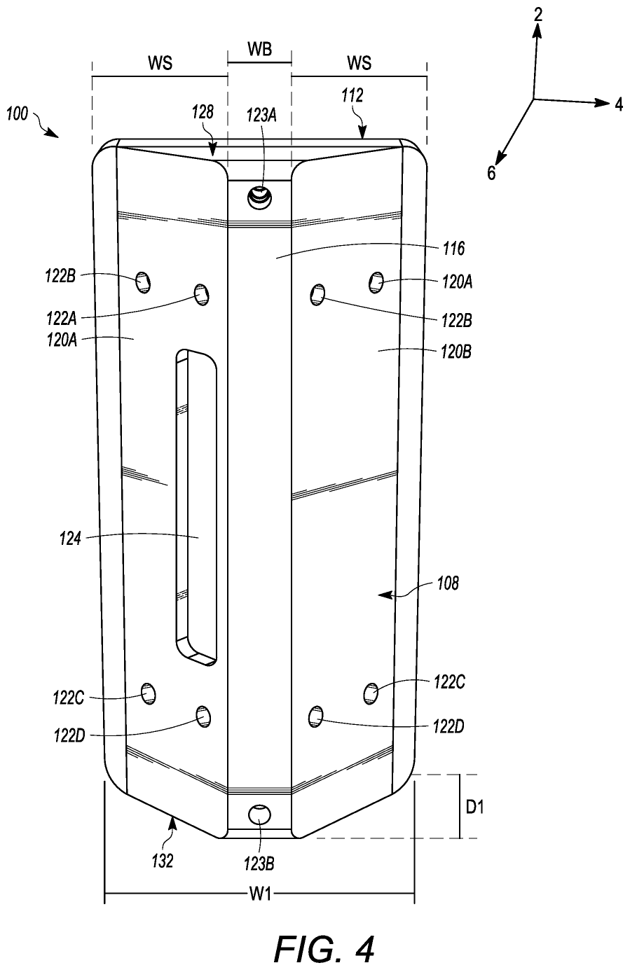

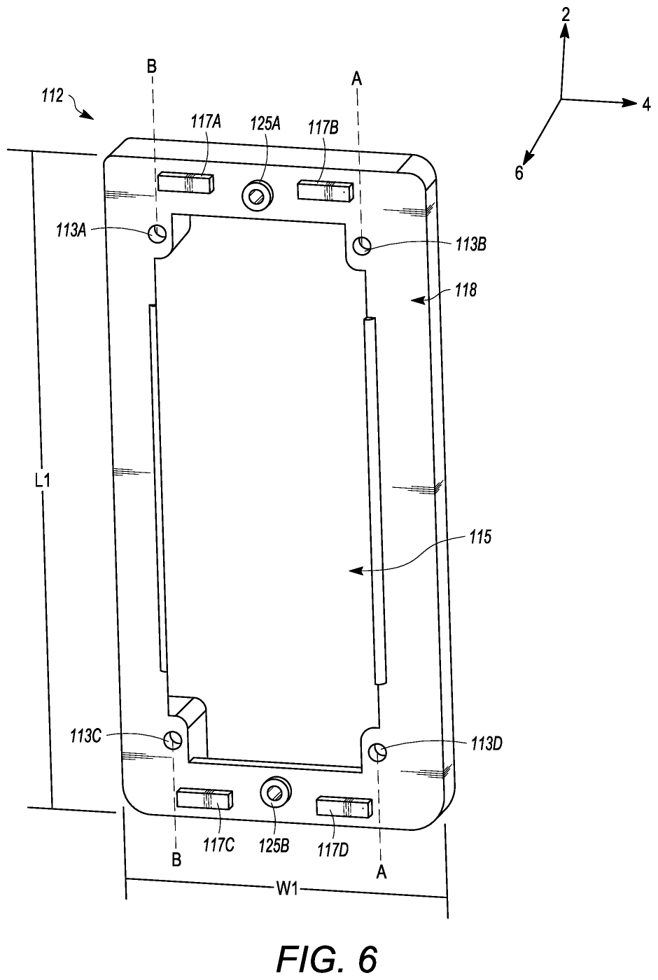

Referring to FIGS. 2-6, the mounting device 100 is utilized for securing the intercom device 14 (not depicted) in a corner defined by two adjacent mounting surfaces 18 (not depicted). In this regard, the mounting device 100 may be referred to as a corner mounting device 100. The mounting device 100 may include a base 108 and a separately attachable front plate 112 that may be coupled to the base 108 during installation. The base 108 and the front plate 112 form a top portion 128 and a bottom portion 132 of the mounting device 100. The base 108 is configured to fit adjacent to two connecting mounting surfaces that define a corner. The surface of the top portion 128 may be convex in shape to prevent liquid or precipitation from collecting on the top of the mounting device 100. The mounting device 100 has a length L1 that extends along a longitudinal direction 2, a width W1 that extends along a lateral direction 4 that is opposite the longitudinal direction 2, and a depth D1 that extends along a transverse direction 6 that is perpendicular to the longitudinal direction 2 and lateral direction 4. In the illustrated embodiment, the length L1 may be about 216.0 mm, the width W1 may be about 105.0 mm, and the depth D1 may be about 53.0 mm. In alternative embodiments, the dimensions of the mounting device 100 may vary and the size is not strictly limited to those recited in this description.

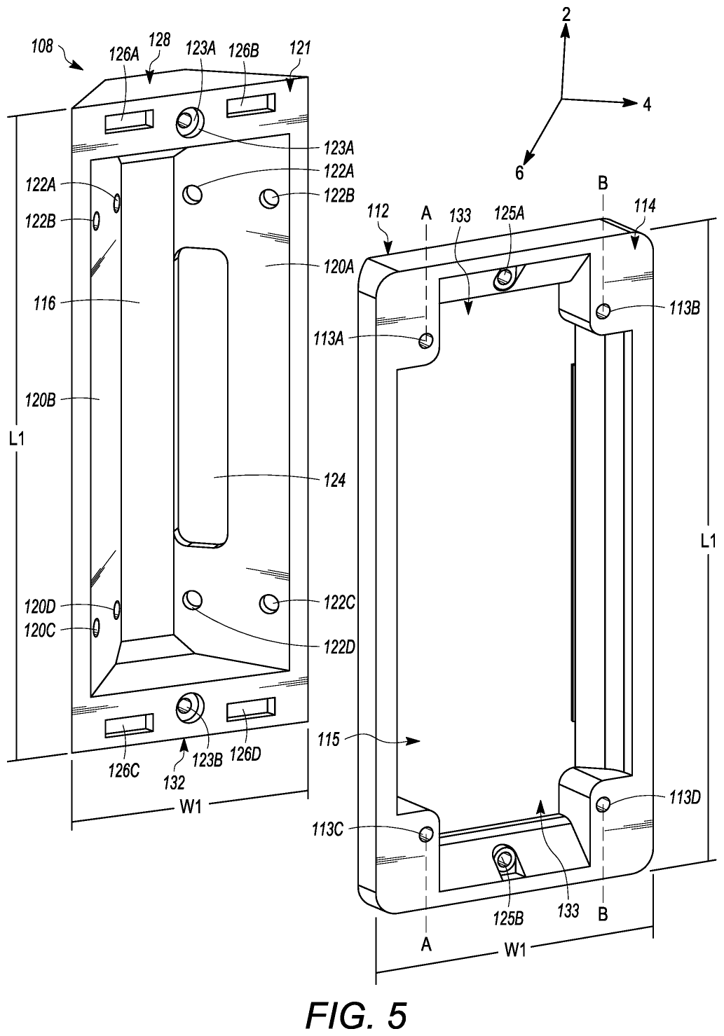

Continuing with FIGS. 2-5, the base 108 includes a back panel 116, side panels 120A, 120B, that extend from the back panel 116 in a direction that is angularly offset relative to the back panel 116, and a front panel 121 attached to the side panels 120 and generally opposite the back panel 116. The base 108 further includes a recess 130 that extends from the front panel 121 and into the base 108 toward the back panel 116. The recess 130 is configured to receive an intercom device 14. As best shown in FIG. 5, the base 108 includes a first set of apertures 123A, 123B, extending from the front panel 121 to the back panel 116. The first set of apertures 123A, 123B (123A and 123B may be used interchangeably with 123 is this disclosure to refer to apertures) are disposed along the same axis aligned with longitudinal direction 2 (axis not shown). The first set of apertures 123A, 123B are configured to allow the base 108 to be coupled to the front plate 112 via anchors inserted through the first set of apertures 123. The anchors may include bolts, screws, or other devices as needed. In alternative embodiments, the anchors may include other fastening mechanisms, including threaded screws, non thread anchors, and any other type of fastener.

The base 108 includes side panels 120A, 120B configured to mate with corner mounting surfaces. The side panels 120A and 120B extend in a generally perpendicular direction with respect each other. More specifically, the side panels 120A and 120B each lie on respective planes (not shown) that intersect and define an angle with respect to each other. The angle is this example may be about 45 degrees. However, the angle may vary from 45 degrees. In the illustrated embodiment, the side panels 120A, 120B, and the back panel 116 are rectangular in shape. The width WS of the side panels 120 are greater than a width WB of the back panel 116 to allow the side panels 120 with a larger surface area to mount onto adjacent surfaces 18. In this configuration, the top portion 128 and the bottom portion 132 are trapezoidal in cross-section. In alternative embodiments, the number and the shape of the side panels 120A, 120B, the back panel 116, the top portion 128, and the bottom portion 132 may vary.

The side panels 120A, 120B may be mounted to directly to the mounting surfaces. As shown, the side panels 120 include a plurality of holes 122 disposed on the side panels 120. The holes 122 are configured to allow the base 108 to be mounted to adjacent surfaces 18 via anchors inserted into the holes 122. In the illustrated embodiment, holes 122A-122D are disposed along each side panel 120A, 120B such that two holes 122A, 122B are disposed on each side panel 120A, 120B near the top portion 128 and two holes 122C, 122D are disposed on each side panel 120A, 120B near the bottom portion 132. The slot 124 is disposed on the side panel 120A. At least one of the side panels 120 includes an opening or slot 124 disposed toward the back panel 116 for receiving electrical components of the intercom device 14 therein. In alternative embodiments, the arrangement of the slot 124 and the plurality of holes 122 on the side panels 120 may vary.

The back panel 116 is coupled to the side panels 120. The back panel 116 is configured to fit into a corner of the adjacent surfaces 18. In one embodiment, the back panel 116 and the side panels 120 further include a neoprene pad configured to couple the mounting device 100 to the corner of the adjacent surfaces 18.

The front panel 121 is adapted to receive and be coupled to the front plate 112. The front panel 122 may include a plurality of grooves 126 disposed on the surface of the front panel 121. The plurality of grooves 126 are configured to couple the front panel 121 to the front plate 112. In the illustrated embodiment, the front panel includes grooves 126A-126D, disposed along a perimeter of the front panel 121. The grooves 126A, 126C are disposed along the same axis, and the grooves 126B, 126D are disposed along an axis parallel to that of the grooves 126A, 126C. In alternative embodiments, the number and positions of the grooves 126 may vary.

Referring to FIGS. 2-6, the front plate 112 is configured to be coupled to the front panel 121 of the base 108. The front plate 112 includes an external facing surface 114, a rear surface 118 opposite the external facing surface 114, and an opening 115 that extends from the external facing surface 114 to the rear surface 118 and is aligned with the recess 130 when the front plate 112 is coupled to the base 108. The mounting device 100 is configured such that a front facing surface of the intercom device 14 is substantially flush with the external facing surface 114 of the front plate when the front plate 112 is coupled to the base 108 and the intercom device 14 is inserted into the recess 130. In the illustrated embodiment, the front plate 112 and the side panels 120 form a cavity 133 toward the top portion 128 and the bottom portion 132 of the mounting device 100 that extends into the opening 115.

The front plate 112 further includes a plurality of threaded inserts 113 configured to couple the front facing surface of the intercom device 14 to the front plate 112. In the illustrated embodiment, the front plate 112 includes threaded inserts 113A-113D disposed along a perimeter of the opening 115. The threaded inserts 113A, 113C are disposed along an axis A-A, and threaded inserts 113B, 113D are disposed along an axis B-B that is parallel to axis A-A. In alternative embodiments, the number and positions of the threaded inserts 113 may vary.

The front plate 112 further includes a plurality of protruding tabs 117 disposed on the rear surface 118 and configured to be received by the plurality of grooves 126 on the front panel 121 of the base 108 to couple the front plate 112 to the base 108. In the illustrated embodiment, the front panel includes tabs 117A-117D, disposed along a perimeter of the opening 115. The tabs 117A, 117C are aligned with, and configured to be received by the grooves 126A, 126C; and the tabs 117B, 117D are aligned with, and configured to be received by the grooves 126B, 126D. In alternative embodiments, the number and position of the tabs 117 may vary and are codependent upon the number and positions of the threaded inserts 113.

The front plate 112 further includes a second set of apertures 125 extending from the from the external facing surface 114 to the rear surface 118. In the illustrated embodiment, the second set of apertures 125A, 125B are disposed along the same axis and are configured to align with the first set of apertures 123A, 123B when the front plate 112 is coupled to the base 108. Thus, the second set of apertures 125A, 125B allow the base 108 to be coupled to the front plate 112 via anchors inserted through the second set of apertures 125A, 125B. In alternative embodiments, the number and position of the second set of apertures 125A, 125B may vary and are codependent upon the number and positions of the first set of apertures 123A, 123B.

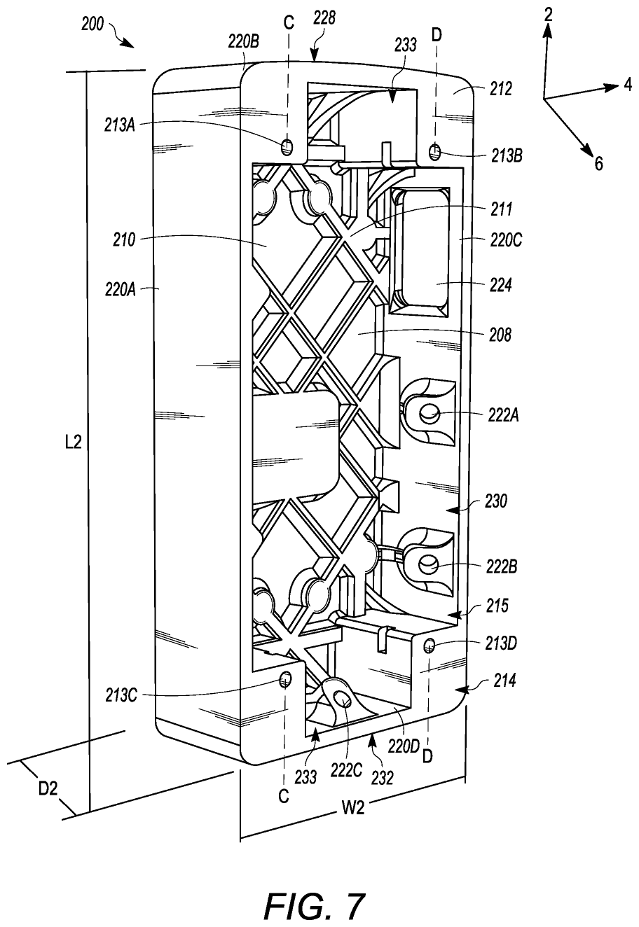

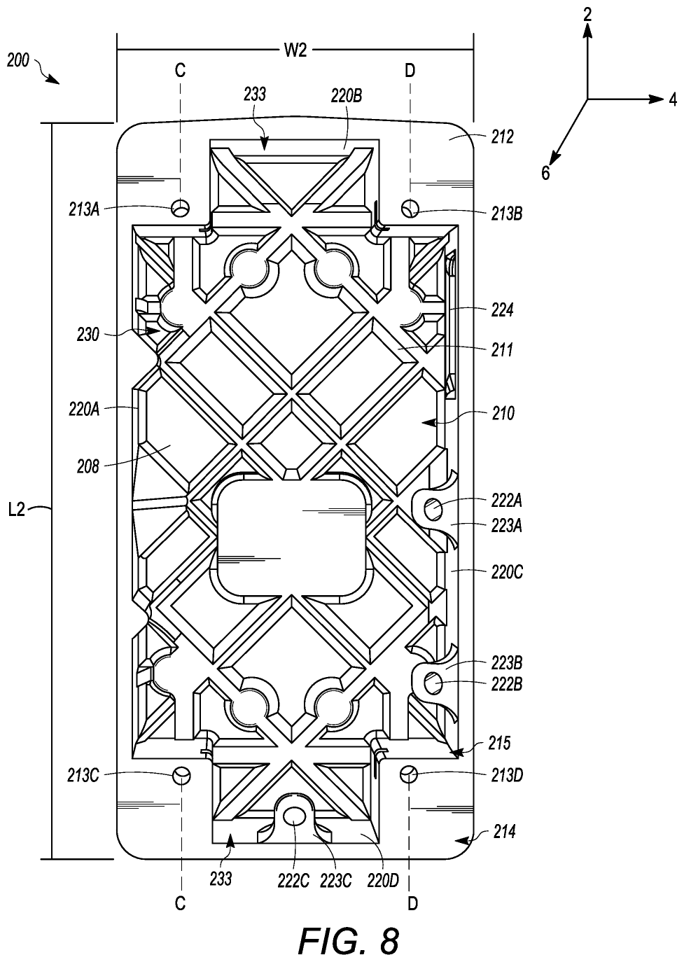

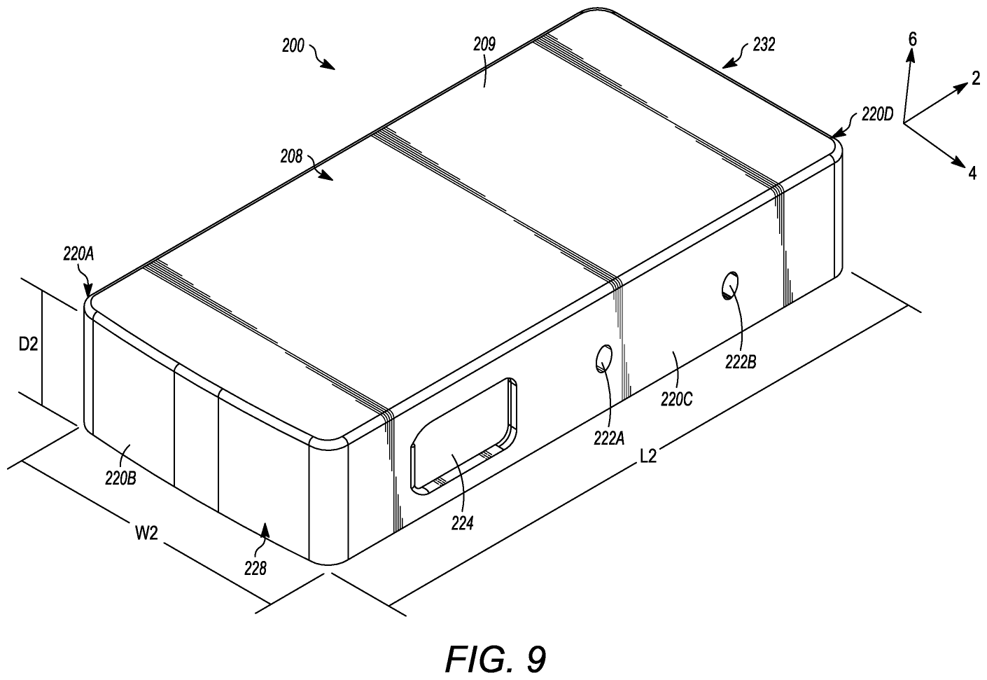

Referring to FIGS. 7-9, the mounting device 200 is utilized for securing the intercom device 14 (not depicted) on a framed surface 18 (not depicted). The mounting device 200 includes a back panel 208, side panels 220 extending from the back panel 208 in a direction that is perpendicular to the back panel 208, and a front panel 212 attached to the side panels 220 and generally opposite the back panel 208. The side panels 220, the back panel 208, and the front panel 212 form a top portion 228 and a bottom portion 232 of the mounting device 200. The top portion 228 may be convex in shape to prevent liquid or precipitation from collecting on the top of the mounting device 200.The mounting device 200 has a length L2 that extends along a longitudinal direction 2, a width W2 that extends along a lateral direction 4 that is opposite the longitudinal direction 2, and a depth D2 that extends along a transverse direction 6 that is perpendicular to the longitudinal direction 2 and lateral direction 4. In the illustrated embodiment, the length L2 may be about 217 mm, the width W2 may be about 105 mm, and the depth D2 may be about 43 mm. In alternative embodiments, the dimensions of the mounting device 200 may vary.

The mounting device 200 further includes a recess 230 that extends from the front panel 212 toward the back panel 208. The recess 230 is configured to receive the intercom device 14. The mounting device 200 is configured such that a front facing surface of the intercom device 14 is substantially flush with the front panel 212 when the intercom device 14 is inserted into the recess 230.

In the illustrated embodiment, the mounting device 200 includes side panels 220A-220D. The side panels 220A-220D are rectangular in shape. The side panels 220A-220D extend in a perpendicular direction from the back panel 208. In the illustrated embodiment, the side panels 220A, 220C have substantially identical dimensions, while the side panels 220B, 220D have substantially identical dimensions. The side panels 220A and 220C extended parallel to each other from the back panel 208 and the side panels 220B, 220D extend parallel to each other from the back panel 208 and perpendicular to the side panels 220A, 220C. In alternative embodiments, the shape and size of the side panels 220 may vary.

Continuing with FIGS. 7-9, the side panels 220 include a plurality of holes 222 disposed on at least one of the side panels 220. The holes 222 are configured to allow the side panels 220 to be mounted to a framed surface 18 via anchors inserted into the holes 222. The holes extend angularly from the surface of the side panels 220 to a tab 223 aligned with the front panel 212. At least one of the side panels 220 includes an opening or slot 224 for receiving electrical components of the intercom device 14 therein. In the illustrated embodiment, holes 222A, 222B are disposed along the side panel 220C and extend angularly to the tabs 223A, 223B, respectively, while a third hole 222C is disposed along the adjacent side panel 220D and extends angularly to the tab 223C. The slot 224 is disposed on the side panel 220C. In alternative embodiments, the arrangement of the slot 224 and the plurality of holes 222 on the side panels 220 may vary.

The back panel 208 may be coupled to the framed surface 18. In the illustrated embodiment, the back panel 208 may be rectangular in shape. In alternative embodiments, the shape of the back panel 208 may vary. The back panel 208 may include an outer surface 209 configured to be coupled to the surface 18 and an inner surface 210 facing the recess 230 and opposite the outer surface 209. In one embodiment, the outer surface 209 further includes a neoprene pad configured to couple the mounting device 200 to the framed surface 18. The device 200 includes a frame 211 configured to maintain structural integrity, rigidity, and impact strength of the mounting device 200. In one example, the frame 211 is a honeycomb frame.

Continuing with FIGS. 7-9, the front panel 212 includes an external facing surface 214, and an opening 215 that extends from the external facing surface 214 and is aligned with the recess 230. The mounting device 200 is configured such that a front facing surface of the intercom device 14 is substantially flush with the external facing surface 214 of the front panel when the intercom device 14 is inserted into the recess 230. In the illustrated embodiment, the front panel 212 and the side panels 220 may form a cavity 233 toward the top portion 228 and the bottom portion 232 of the mounting device 200 that extends into the opening 215.

The front panel 212 further includes a plurality of bolt holes 213 configured to couple the front facing surface of the intercom device 14 to the front panel 212. In the illustrated embodiment, the front panel 212 includes bolt holes 213A-213D disposed along a perimeter of the opening 215. The bolt holes 213A, 213C are disposed along a longitudinal axis C-C, while the bolt holes 213B, 213D are disposed along a longitudinal axis D-D that is parallel to axis C-C. In alternative embodiments, the number and positions of the bolt holes 213 may vary.

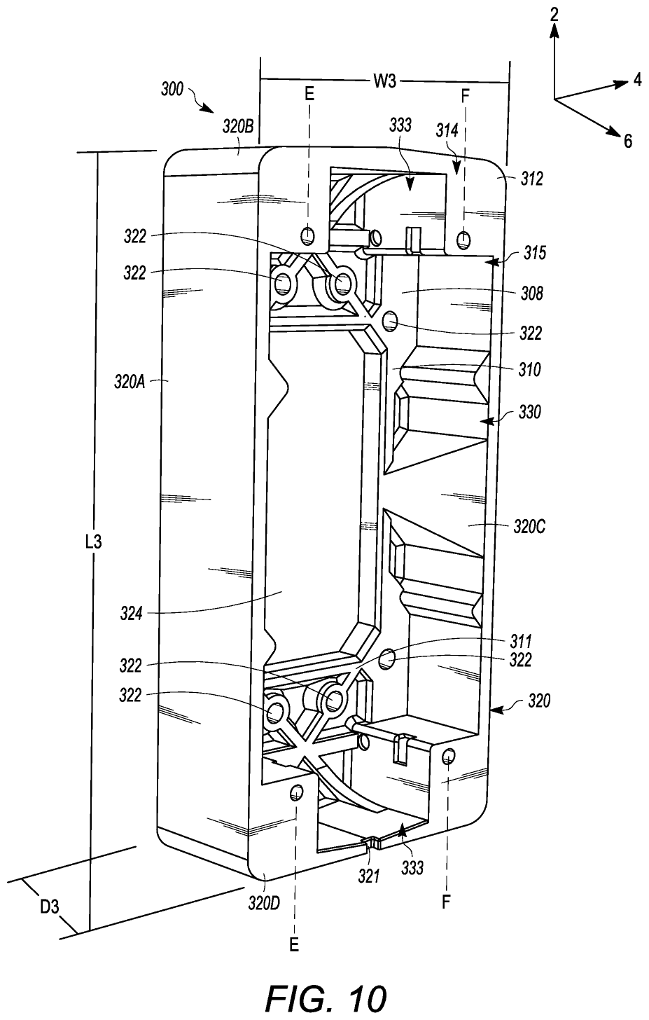

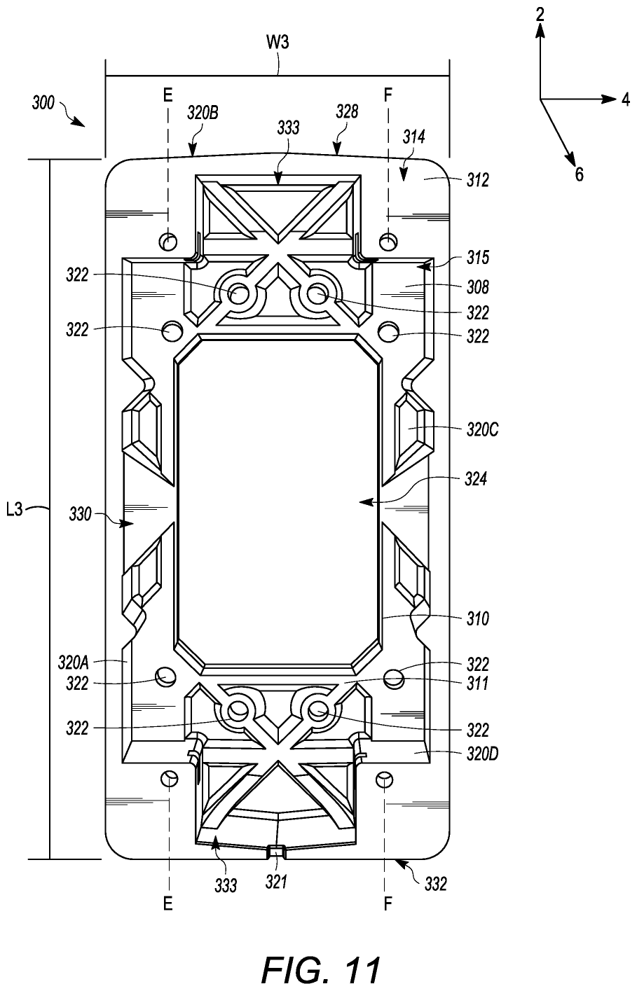

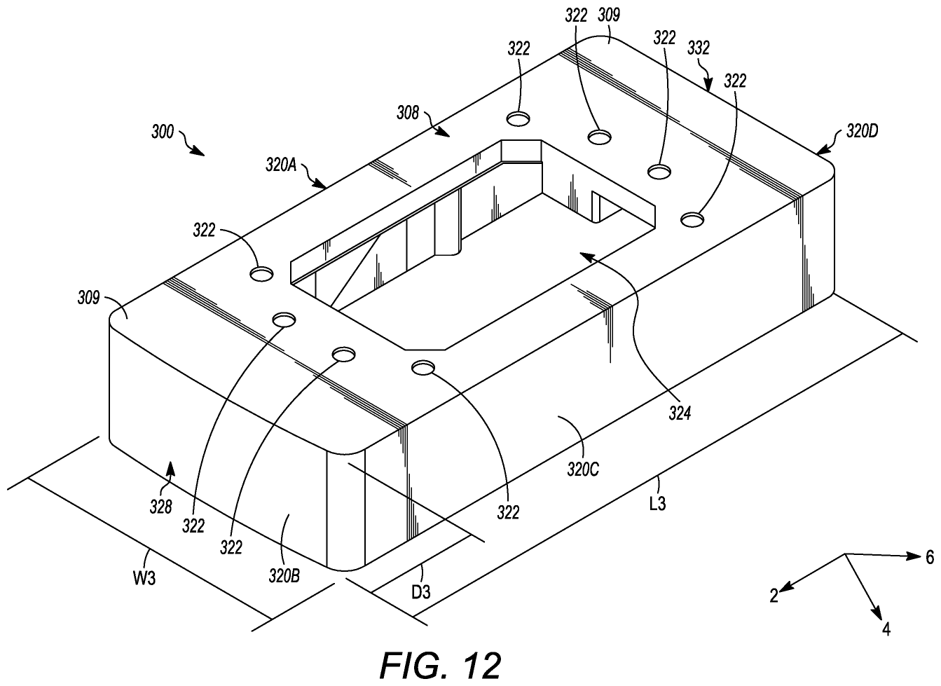

Referring to FIGS. 10-12, the mounting device 300 is utilized for securing the intercom device 14 (not depicted) in an opening of a surface 18 (not depicted). The mounting device 300 includes a back panel 308, side panels 320 extending from the back panel 308 in a direction that is perpendicular to the back panel 308, and a front panel 312 attached to the side panels 320 and generally opposite the back panel 308. The side panels 320, the back panel 308, and the front panel 312 form a top portion 328 and a bottom portion 332 of the mounting device 300. The top portion 328 may be convex in shape to prevent liquid or precipitation from collecting on the top of the mounting device 300. The bottom portion 332 includes a drainage port 321 configured to drain liquid or precipitation from the mounting device 300. In the illustrated embodiment, the mounting device 300 has a length L3 that extends along a longitudinal direction 2, a width W3 that extends along a lateral direction 4 that is opposite the longitudinal direction 2, and a depth D3 that extends along a transverse direction 6 that is perpendicular to the longitudinal direction 2 and lateral direction 4. In the illustrated embodiment, the length L3 may be about 217 mm, the width W3 may be about 105 mm, and the depth D3 may be about 43 mm. In alternative embodiments, the dimensions of the mounting device 300 may vary.

The mounting device 300 further includes a recess 330 that extends from the front panel 312 toward the back panel 308. The recess 330 is configured to receive the intercom device 14. The mounting device 300 is configured such that a front facing surface of the intercom device 14 is substantially flush with the front panel 312 when the intercom device 14 is inserted into the recess 330.

In the illustrated embodiment, the mounting device 300 includes side panels 320A-320D. The side panels 320A-320D are rectangular in shape. The side panels 320A-320D extend in a perpendicular direction from the back panel 308. In the illustrated embodiment, the side panels 320A, 320C have identical dimensions, while the side panels 320B, 320D have identical dimensions. The side panels 320A and 320C extended parallel to each other from the base 308 and the side panels 320B, 320D extend parallel to each other from the base 308 and perpendicular to the side panels 320A, 320C.

Continuing with FIGS. 10-12, the back panel 308 may be coupled to the framed surface 18. In the illustrated embodiment, the back panel 308 may be rectangular in shape. In alternative embodiments, the shape of the back panel 308 may vary. The back panel 308 may include an outer surface 309 configured to be coupled to the surface 18 and an inner surface 310 facing the recess 330 and opposite the outer surface 309. In one embodiment, the outer surface 309 further includes a neoprene pad configured to couple the mounting device 300 to the framed surface 18. In the illustrated embodiment, the inner surface 310 includes a frame 311 configured to maintain structural integrity, rigidity, and impact strength of the mounting device 300. In one example, the frame 311 is a honeycomb frame.

The back panel 308 includes an opening or slot 324 for receiving electrical components of the intercom device 14 therein. The back panel 308 includes a plurality of holes 322 disposed on the back panel 308 around a perimeter of the slot 324. The holes 322 are configured to allow the back panel 308 to be mounted to an opening of a surface 18 via anchors inserted into the holes 322. In alternative embodiments, the arrangement of the slot 324 and the plurality of holes 322 on the back panel 308 may vary.

Continuing with FIGS. 10-12, the front panel 312 includes an external facing surface 314, and an opening 315 that extends from the external facing surface 314 and is aligned with the recess 330. The mounting device 300 is configured such that a front facing surface of the intercom device 14 is substantially flush with the external facing surface 314 of the front panel when the intercom device 14 is inserted into the recess 330. In the illustrated embodiment, the front panel 312 and the side panels 320 form a cavity 333 toward the top portion 328 and the bottom portion 332 of the mounting device 300 that extends into the opening 315.

The front panel 312 further includes a plurality of bolt holes 313 configured to couple the front facing surface of the intercom device 14 to the front panel 312. In the illustrated embodiment, the front panel 312 includes bolt holes 313A-313D disposed on the front panel 312 along a perimeter of the opening 315. The bolt holes 313A, 313C are disposed along a longitudinal axis E-E, while the bolt holes 313B, 313D are disposed along a longitudinal axis F-F that is parallel to axis E-E. In alternative embodiments, the number and positions of the bolt holes 313 may vary.

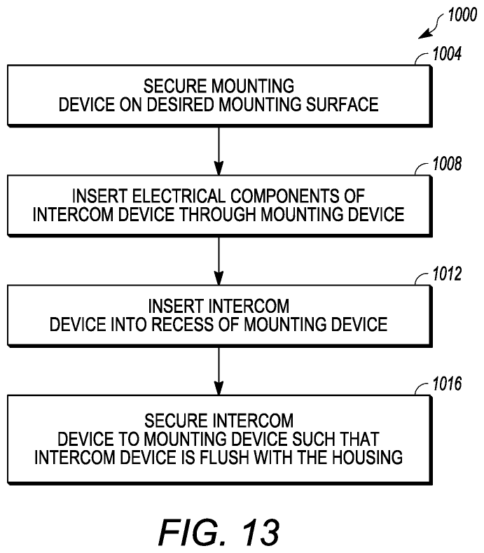

Now referring to FIG. 13, a method 1000 for installing the intercom device 14 utilizing the mounting device 100, 200, 300 will be described. The mounting device 100, 200, 300 includes a recess for receiving the intercom device 14. In step 1004, the mounting device 100, 200, 300 is secured on a desired mounting surface 18.

In one embodiment, a base of the mounting device 100 is coupled to the desired mounting surface 18 via at least one anchor. the base has a back panel, side panels that extend from the back panel in a direction that is angularly offset relative to the back panel, a front panel attached to the side panels and generally opposite the back panel, and a recess that extends in to the base toward the back panel, where the recess is configured to receive an intercom device. A front plate of the mounting device 100 is coupled to the front panel of the base via at least one anchor. The front plate has an external facing surface, a rear surface opposite the external facing surface, and an opening that extends from the external facing surface to the rear surface and is aligned with the recess when the front plate is coupled to the base. The intercom device 14 is mounted in the recess via at least one anchor such that a front facing surface of the intercom device 14 is substantially flush with the external facing surface of the front plate.

In another embodiment, a front panel of the mounting device 200 is coupled to a surface 18 via at least one anchor. At least one side panel of the mounting device 200 is coupled to the surface 18 via at least one anchor. The intercom device 14 is mounted in the recess via at least one anchor such that a front facing surface of the intercom device 14 is substantially flush with the front panel.

In another embodiment, a back panel of the mounting device 200 is coupled an opening of the desired mounting surface 18 via at least one anchor. The intercom device 14 is mounted in the recess via at least one anchor such that a front facing surface of the intercom device 14 is substantially flush with the front panel and the desired mounting surface 18.

In step 1008, electrical components of the intercom device 14 is inserted through the mounting device 100, 200, 300. In step 1012, the intercom device 14 is inserted into the recess of the mounting device 100, 200, 300. In step 1016, the intercom device 14 is secured to the mounting device 100, 200, 300 such that the intercom device 14 is flush with the mounting device 100, 200, 300.

While the disclosure is described herein, using a limited number of embodiments, these specific embodiments are not intended to limit the scope of the disclosure as otherwise described and claimed herein. The precise arrangement of various elements and order of the steps of articles and methods described herein are not to be considered limiting. For instance, although the steps of the methods are described with reference to sequential series of reference signs and progression of the blocks in the figures, the method can be implemented in an order as desired.

1. A system for an intercom device, comprising:
a corner mounting device having
1) a base having a back panel, side panels that extend from the back panel in a direction that is angularly offset relative to the back panel, a front panel attached to the side panels and generally opposite the back panel, and a recess that extends in to the base toward the back panel, the recess configured to receive an intercom device; and
2) a front plate configured to be coupled to the front panel of the base, the front plate having an external facing surface, a rear surface opposite the external facing surface, and an opening that extends from the external facing surface to the rear surface and is aligned with the recess when the front plate is coupled to the base,
wherein a front facing surface of the intercom device is substantially flush with the external facing surface of the front plate when the intercom device is inserted into the recess.

2. The system of claim 1, wherein the front plate includes a plurality of threaded inserts configured to couple the front facing surface of the intercom device to the front plate.

3. The system of claim 1, wherein the front plate is coupled to the front panel of the base via a plurality of bolts.

4. The system of claim 1, wherein the base and the front plate form a top portion and a bottom portion of the corner mounting device.

5. The system of claim 4, wherein the top portion is convex in shape.

6. The system of claim 1, wherein at least one of the side panels includes a plurality of holes configured to mount the base to adjacent mounting surfaces.

7. The system of claim 1, wherein at least one of the side panels includes an opening for receiving electrical components therein.

8. The system of claim 1, wherein the rear surface of the front plate further includes a plurality of protruding tabs configured to be received by the front panel of the base.

9. A system, comprising:
a frame mounting device having a back panel, side panels that extend from the back panel in a direction that is perpendicular to the back panel, a front panel attached to the side panels and generally opposite the back panel, and a recess that extends toward the back panel, the recess configured to receive an intercom device,
wherein a front facing surface of the intercom device is substantially flush with the front panel when the intercom device is mounted in the recess of the frame mounting device.

10. The system of claim 9, wherein the front panel includes a plurality of threaded inserts configured to couple the front facing surface of the intercom device to the front panel.

11. The system of claim 9, wherein the frame mounting device further includes a top portion and a bottom portion.

12. The system of claim 11, wherein the top portion is convex in shape.

13. The system of claim 9, wherein the front panel includes a plurality of holes configured to mount the front panel to one or more frames.

14. The system of claim 9, wherein the side panels each includes at least one hole configured to mount the side panels to one or more frames.

15. The system of claim 9, wherein at least one of the side panels includes an opening for receiving electrical components therein.

16. A system, comprising:
a surface mounting device having a back panel, side panels that extend from the back panel in a direction that is perpendicular to the back panel, a front panel attached to the side panels and generally opposite the back panel, and a recess that extends toward the back panel, the recess configured to receive an intercom device;
wherein a front facing surface of the intercom device is substantially flush with the front panel when the intercom device is mounted in the recess of the surface mounting device.

17. The system of claim 16, wherein the front panel includes a plurality of threaded inserts configured to couple the front facing surface of the intercom device to the front panel.

18. The system of claim 16, wherein the surface mounting device includes a top portion and a bottom portion.

19. The system of claim 18, wherein the top portion is convex in shape.

20. The system of claim 16, wherein the back panel includes a plurality of holes configured to mount the back panel to a surface.

21. The system of claim 16, wherein at least one of the side panels include a drainage port.

22. The system of claim 16, wherein the back panel includes an opening for receiving electrical components therein.

23. A method, comprising:
securing a mounting device on a desired mounting surface, the mounting device having a recess for receiving an intercom device;
inserting electrical components of the intercom device through the mounting device;
inserting the intercom device into the recess of the mounting device; and
securing the intercom device to the mounting device such that the intercom device is flush with a housing.

24. The method of claim 23, wherein securing the mounting device includes coupling a base of the mounting device to the desired mounting surface via at least one anchor, the base having a back panel, side panels that extend from the back panel in a direction that is angularly offset relative to the back panel, a front panel attached to the side panels and generally opposite the back panel, and a recess that extends in to the base toward the back panel, the recess configured to receive an intercom device.

25. The method of claim 24, further comprising coupling a front plate of the mounting device to the front panel of the base via at least one anchor, the front plate having an external facing surface, a rear surface opposite the external facing surface, and an opening that extends from the external facing surface to the rear surface and is aligned with the recess when the front plate is coupled to the base.

26. The method of claim 25, wherein securing the intercom device includes mounting the intercom device in the recess via at least one anchor such that a front facing surface of the intercom device is substantially flush with the external facing surface of the front plate.

27. The method of claim 23, wherein securing the mounting device includes coupling a front panel of the mounting device to a frame via at least one anchor.

28. The method of claim 27, wherein securing the mounting device includes coupling at least one side panel of the mounting device to the frame via at least one anchor.

29. The method of claim 28, wherein securing the intercom device includes mounting the intercom device in the recess via at least one anchor such that a front facing surface of the intercom device is substantially flush with the front panel.

30. The method of claim 29, wherein securing the mounting device includes coupling a back panel of the mounting device into an opening of the desired mounting surface via at least one anchor.

31. The method of claim 30, wherein securing the intercom device includes mounting the intercom device in the recess via at least one anchor such that a front facing surface of the intercom device is substantially flush with the front panel and the desired mounting surface.
